(19) United States
(12) Patent Application Publication
(10) Pub. No.: US 2026/0133626 A1
(43) Pub. Date: May 14, 2026

(54) VISION-BASED AIMPOINT NAVIGATION AND LINE-OF-SIGHT TRACKING SYSTEM AND METHOD

(71) Applicant: BAE SYSTEMS Information and Electronic Systems Integration Inc., Nashua, NH (US)

(72) Inventors: Helen F. Webb, Malden, MA (US); Sowmya Ramakrishnan, Kendall Park, NJ (US); Peter Dusaitis, Manchester, NH (US)

(73) Assignee: BAE SYSTEMS Information and Electronic Systems Integration Inc., Nashua, NH (US)

(21) Appl. No.: 18/807,207

(22) Filed: Aug. 16, 2024

(51) Int. Cl. G06F 3/01; G06T 3/14; G06T 5/50; G06T 5/77; G06T 7/246; G06T 7/33; G06T 7/73; G06T 15/20

(52) U.S. Cl. CPC G06F 3/013; G06T 3/14; G06T 5/50; G06T 5/77; G06T 7/248; G06T 7/251; G06T 7/344; G06T 7/74; G06T 7/75; G06T 15/20; G06T 2207/10016; G06T 2207/10048; G06T 2210/56

(57) ABSTRACT

A line-of-sight aimpoint tracking system includes a model projecting module that converts a 3D model of an area of interest into a 2D projected image from a platform viewpoint, incorporating an aimpoint in its vicinity, based on platform position and attitude measurement information. A registering/tracking module aligns this 2D projected image with a real image captured by a video source on the platform, and identifies the aimpoint's pixel location within the real image. After the correlation between the real image and the 3D model has been established based on location information from a GPS, or the like, combined with image registration to perform aimpoint-cueing, interframe registration enables the aimpoint to be tracked based on image information in the absence of location information from the GPS, or the like. A line-of-sight estimator then calculates pointing angles of a line-of-sight vector to the aimpoint and provides them to a navigation system.

### STATEMENT OF GOVERNMENT INTEREST

This invention was made with government support under Contract No. FA8651 20 C 0043 awarded by AFRL. The United States Government has certain rights in this invention.

This application incorporates by reference, for all purposes, U.S. Pat. No. 10,445,616B2.

### FIELD OF THE DISCLOSURE

The present disclosure relates to guidance and navigation systems, particularly to vision-based precision targeting and navigation in GPS-denied, GPS-degraded, or contested environments.

### BACKGROUND

Navigation systems are essential for the accurate positioning and orientation of airborne platforms, particularly in built up urban areas. These systems encounter significant difficulties when faced with signal interference or obstruction, which can occur in environments where access to satellite-based navigation aids is intentionally disrupted. The phase of an operation that involves closing in on a target is particularly sensitive to such disruptions, as the precision of navigation is of great importance.

Therefore, there is a need for a navigation solution that remains robust in environments where satellite-based aids are compromised. A system capable of providing accurate and precise positioning information, even when these aids are unavailable, would be highly beneficial, particularly in the context of operations within complex and contested urban landscapes.

### SUMMARY

One embodiment provides a line-of-sight (LOS) aimpoint tracking system comprising: a model projecting module configured to receive a 3D model of an area of interest, to receive an aimpoint that is located in the vicinity of the area of interest in a global reference frame, to receive platform position and attitude measurement information indicating a platform viewpoint, and to convert the 3D model of the area of interest to a 2D projected image, including the aimpoint, as viewed from the platform viewpoint; and a registering/tracking module configured to receive the 2D projected image from the model projecting module, to receive an image corresponding to the platform viewpoint, to register the 2D projected image with the image corresponding to the platform viewpoint, and to determine, in the image corresponding to the platform viewpoint, an aimpoint pixel location corresponding to the aimpoint, wherein the determination of the aimpoint pixel location in the image using the projected 3D model is termed as ‘cueing’ the aimpoint.

Another embodiment provides such a line-of-sight aimpoint tracking system, wherein the image corresponding to the platform viewpoint is obtained by a video source configured to capture image data comprising image frames.

A further embodiment provides such a line-of-sight aimpoint tracking system, wherein the video source is an infrared camera.

Yet another embodiment provides such a line-of-sight aimpoint tracking system, wherein the platform-mounted video source is pointed to have, in its field of view, the area of interest wherein the aimpoint is located.

A yet further embodiment provides such a line-of-sight aimpoint tracking system, further comprising a distortion removing module configured to receive the platform viewpoint image and to remove distortion therefrom to produce an undistorted image corresponding to the platform viewpoint image, and to output the undistorted image corresponding to the platform viewpoint image to the registering module.

Still another embodiment provides such a line-of-sight aimpoint tracking system, wherein the model projecting module is configured to receive or calculate a line-of-sight vector from the platform position to the aimpoint, to calculate the plane that includes the aimpoint and is orthogonal to the line-of-sight vector, to project, onto that plane, vertices from the 3D model of the area of interest, and to in-fill spaces between the projected vertices to form a projected 2D image of the model of the area of interest as if viewed from the viewpoint of the platform.

A still further embodiment provides such a line-of-sight tracking system, wherein the registering/tracking module is configured to perform image registration to align the projected and in-filled 2D image of the model of the area of interest with an image of the area of interest acquired by the video source.

Still another embodiment provides such a line-of-sight aimpoint tracking system wherein the registering/tracking module is configured to locate a pixel, corresponding to a 3D aimpoint that is within the area of interest, on an image acquired by the video source using such image registration.

A still further embodiment provides such a line-of-sight aimpoint tracking system, wherein the registering/tracking module is configured to perform interframe registration to track the aimpoint in a subsequent image from the video source.

A still further embodiment provides such a line-of-sight aimpoint tracking system wherein the registering/tracking module is configured to keep track of the aimpoint position in a subsequent image by projecting forward an aimpoint pixel location using a transform computed from interframe image registration.

Even another embodiment provides a non-transitory computer-readable medium storing a plurality of instructions which when executed by one or more processors causes the one or more processors to perform a method for line-of-sight aimpoint tracking comprising: a method for line-of-sight aimpoint tracking comprising: receiving aimpoint position information; receiving platform position and attitude measurement information corresponding to a current position of a platform; obtaining a platform viewpoint image from a platform-mounted video source; generating a 2D projected image through projecting at least a portion of a 3D model of an area of interest containing the aimpoint onto a plane from a platform viewpoint based on the received position and attitude measurement information; locating the aimpoint within the generated 2D projected image; using image registration to register the 2D projected image with an image corresponding to the platform viewpoint image; based on the registration between the image corresponding to the platform viewpoint image and the 2D projected image, locating a pixel position of the aimpoint in the image corresponding to the platform image; and tracking the pixel position of the aimpoint through interframe registration to predict a location of the aimpoint in an image corresponding to a subsequent platform image.

An even further embodiment provides such a non-transitory computer-readable medium, wherein generation of the 2D projected image, including the aimpoint, as viewed from the platform viewpoint comprises calculating a line-of-sight vector from the platform position to the aimpoint, calculating the plane that includes the aimpoint and that is orthogonal to the line-of-sight vector, projecting, onto that plane, vertices from the 3D model, and in-filling spaces between the projected vertices.

A still even another embodiment provides such a non-transitory computer-readable medium, wherein tracking the pixel position of the aimpoint through interframe registration is carried out even when platform position and/or attitude information can no longer be received.

A still even further embodiment provides such a non-transitory computer-readable medium, wherein the interframe registration comprises feature-based interframe registration.

Still yet another embodiment provides such a non-transitory computer-readable medium, wherein Speeded Up Robust Features are used for interframe registration.

A still yet further embodiment provides such a non-transitory computer-readable medium, wherein the interframe registration comprises matching features that are confined to a local window in the vicinity of the acquired aimpoint.

Even yet another embodiment provides such a non-transitory computer-readable medium, wherein the 3D model is a wireframe model or a point cloud model.

Even yet further embodiment provides such a non-transitory computer-readable medium, further comprising removing of distortion from the platform viewpoint image based on data regarding distortion in the video source.

Still even yet another embodiment provides such a non-transitory computer-readable medium, further comprising distorting the 2D projected image based on data regarding distortion in the video source.

A still even yet further embodiment provides such a non-transitory computer-readable medium, further comprising enhancing higher-frequency spatial features of the 3D model and/or the 2D projected image.

Yet still even another embodiment provides a vision-based aimpoint navigation system comprising: a platform position information generating device; a mission computer; a video source; a line-of-sight aimpoint tracking system set forth in claim 1; and a line-of-sight estimator configured to calculate an estimated LOS vector in terms of the pointing angles (an azimuth and an elevation) from the platform viewpoint to the aimpoint.

A yet still even further embodiment provides a non-transitory computer-readable medium storing a plurality of instructions which when executed by one or more processors causes the one or more processors to perform a vision-based aimpoint navigation method comprising: receiving aimpoint position information corresponding to an aimpoint; receiving platform position and attitude measurement information corresponding to a current position of a platform; obtaining a platform viewpoint image from a video source at a platform viewpoint; generating a 2D projected image through projecting a 3D model of an area of interest onto a plane from a platform viewpoint based on the received position and attitude measurement information; locating the aimpoint within the generated 2D projected image; using image registration to register the 2D projected image with an image corresponding to the platform viewpoint image; based on the registration between the image corresponding to the platform viewpoint image and the 2D projected image, locating a pixel position of the aimpoint in the image corresponding to the platform image, i.e. cueing the aimpoint pixel location; tracking the pixel position of the aimpoint through interframe registration to identify a location of the aimpoint in an image corresponding to a subsequent platform image; calculating an estimated LOS vector (an azimuth and an elevation) from a platform viewpoint to the aimpoint; and carrying out guidance, navigation and control operations based on platform position and attitude measurement information if current platform position and attitude measurement information is available, and carrying out guidance, navigation and control operations based on the estimated LOS vector if current platform position and attitude measurement information is not available.

Implementations of the techniques discussed above may include a method or process, a system or apparatus, a kit, or a computer software stored on a computer-accessible medium. The details of one or more implementations are set forth in the accompanying drawings and the description below. Other features will be apparent from the description and drawings, and from the claims.

The features and advantages described herein are not all-inclusive and, in particular, many additional features and advantages will be apparent to one of ordinary skill in the art in view of the drawings, specification, and claims. Moreover, it should be noted that the language used in the specification has been selected principally for readability and instructional purposes and not to limit the scope of the inventive subject matter.

### BRIEF DESCRIPTION OF THE DRAWINGS

FIG. 1 is a flow chart illustrating a method for vision-based aimpoint navigation including cueing and tracking phases, in accordance with embodiments of the present disclosure;

FIG. 2 is a block illustrating a vision-based aimpoint navigation system including a line-of-sight (LOS) aimpoint tracking system, in accordance with embodiments of the present disclosure;

FIG. 3 is a flow chart outlining process steps for aimpoint tracking and line-of-sight vector calculation, in accordance with embodiments of the present disclosure;

FIG. 4 is a flow chart outlining process steps for aimpoint tracking and guidance operations in a vision-based navigation system, in accordance with embodiments of the present disclosure; and

FIG. 5 is a diagram illustrating the line-of-sight vector from the video source to the aimpoint.

These and other features of the present embodiments will be understood better by reading the following detailed description, taken together with the figures herein described. The accompanying drawings are not intended to be drawn to scale. For purposes of clarity, not every component may be labeled in every drawing.

### DETAILED DESCRIPTION

The field of vision-based precision targeting, particularly in GPS-denied or degraded environments during terminal approach phases, presents significant challenges. Airborne platforms, such as missiles and unmanned aerial vehicles, require reliable and precise navigation to reach designated aimpoints in urban environments. Traditional Guidance, Navigation, and Control (GNC) solutions, while effective during high-altitude ingress phases, often fail to provide the accuracy and reliability for precision navigation as the platform enters the final approach, which is often under Anti-Access/Area Denial (A2AD) conditions. This final approach phase, typically at ranges of approximately 500 meters to the target, is critical for mission success and demands a high degree of navigational precision to ensure the platform reaches the designated aimpoint.

Existing solutions for precision targeting and self-locating of airborne platforms in urban environments face significant shortcomings under A2AD conditions. The reliance on GPS for navigation can become a vulnerability when GPS signals are jammed or otherwise unavailable. This limitation poses a substantial risk to the success of missions, as platforms might not be able to accurately locate and track aimpoints in the environment, such as designated points on buildings or locations between buildings, especially as inertial navigation tools lack adequate accuracy and are sensitive to external noise sources. The need for the development of an alternative navigation solution that operates independently of GPS signals is evident, particularly for the final approach phase where precision is of high importance.

The present disclosure introduces a line-of-sight (LOS) aimpoint tracking system and a vision-based aimpoint navigation solution that operates effectively in GPS-denied and degraded environments. This system utilizes a platform's vision sensor (such as a video camera or forward-looking infrared camera) to track an aimpoint and generate line-of-sight vectors, enabling precise navigation to the aimpoint independently of GPS navigation systems.

In embodiments, the system comprises a model projecting module, a registering/tracking module, and a line-of-sight estimator. The model projecting module is configured to receive a 3D model of an area of interest and convert the 3D model into a 2D projected image from a specific viewpoint that is congruent with a known location of the platform, incorporating an aimpoint that is within the environment. The 3D model may be a wireframe model or a point cloud model. The registering/tracking module aligns this 2D projected image with an actual image from the platform's viewpoint and identifies the aimpoint's pixel location within this image. The line-of-sight estimator calculates an estimated line-of-sight vector from the platform to the aimpoint. This approach provides a robust solution for precision targeting in challenging environments, enhancing the capabilities of small form-factor weapons, drones, and unmanned aerial surveillance systems, hereinafter termed in general “directable platforms.”

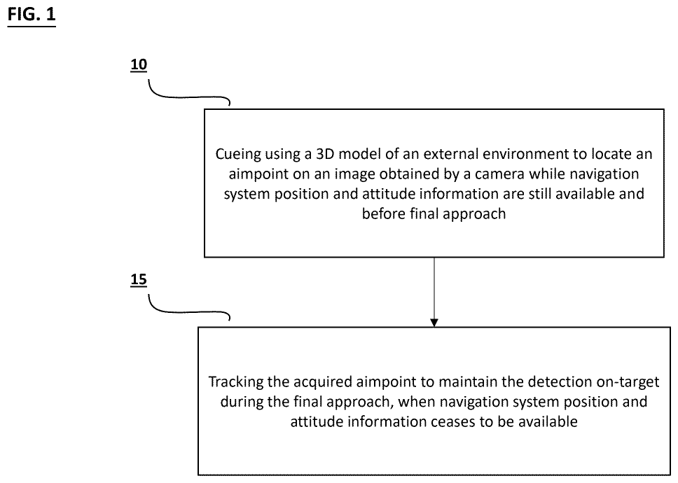

FIG. 1 illustrates one embodiment of a method for vision-based aimpoint navigation. The method comprises two main steps: cueing using a 3D model of an external environment to locate an aimpoint on an image obtained by a vision sensor such as a camera while sensor position and attitude measurement information are still available; and tracking the acquired aimpoint to maintain detection on-target during the final approach when sensor position and attitude measurement information are no longer available. This method can be implemented by components such as a camera serving as a video source and utilizing sensor position and attitude measurement information from, for example, a global positioning system (GPS). Cueing 10 using a 3D model of an external environment comprises locating an aimpoint on an image obtained by a camera while sensor position and attitude measurement information are still available, setting the stage for the subsequent tracking process.

Embodiments include tracking 15 the acquired aimpoint to maintain the detection on-target during the final approach. This step becomes operative when sensor position information is no longer available, ensuring that the aimpoint line of sight remains available to the platform's guidance system.

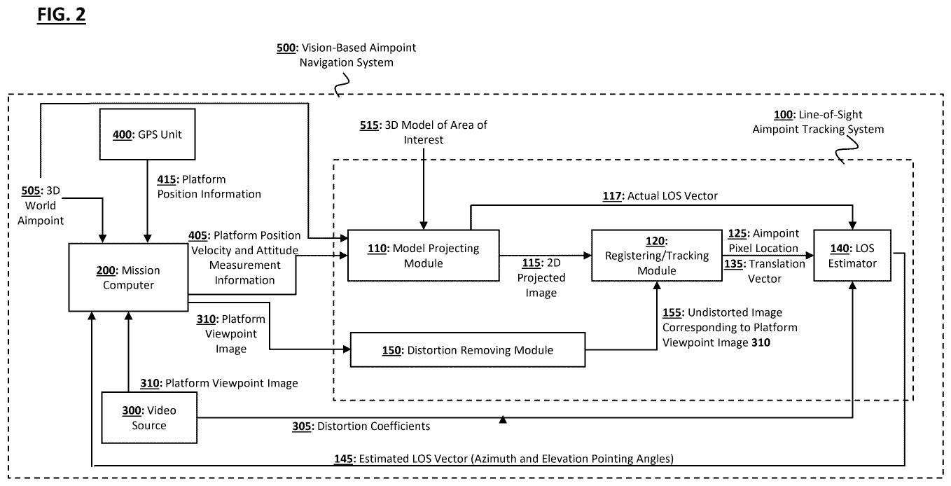

FIG. 2 shows the components and interactions within a vision-based aimpoint navigation system 500 of embodiments, designed to include line-of-sight aimpoint tracking. The system 500 integrates a mission computer 200, a GPS Unit 400 (a platform navigation position information generating device), a video source 300, a model projecting module 110, a distortion removing module 150, a registering/tracking module 120, and a LOS estimator 140. Note that the distortion removing module 150 is not absolutely necessary, and in some embodiments may be omitted. Note also that, in the below, the model projecting module 110, the registering/tracking module 120, the LOS estimator 140, and the distortion removing module 150, if provided, may be referred to collectively as a line-of-sight aimpoint tracking system 100. In embodiments the system 500 operates using a 3D model of an area of interest 515 and a 3D world aimpoint 505 (i.e., an aimpoint that is defined in terms of a three-dimensional coordinate location in a global reference frame, such as, for example, longitude, latitude, and elevation coordinates) to guide a platform through environments where GPS signals could be compromised. Note that there is no limitation to the use of a GPS for the GPS unit 400, but any device, mounted on the platform or not, that produces information regarding the position of the platform may be used for the platform position information generating device.

In some embodiments the mission computer 200, as a centralized controller, receives an input of the 3D world aimpoint 505 and platform position measurement information 415, while in other embodiments these may be inputted into the model projecting module 110 directly. The video source 300, with inherent distortion coefficients 305 (which are data pertaining to distortion), captures platform viewpoint images 310. The model projecting module 110 utilizes the 3D model 515 of the area of interest and the platform position, velocity and attitude measurement information 405 to create a 2D projected image 115 from the viewpoint of the platform (hereinafter termed a “platform viewpoint”). In embodiments this may be performed through known geometrical techniques where a line-of-sight vector, calculated based on the location of the platform that is known from, for example, GPS and attitude data, is drawn from the platform viewpoint to the aimpoint, a plane that is orthogonal to the LOS vector is calculated, and features of the 3D model 515 are projected onto this plane. In some embodiments the distortion removing module 150 receives a platform viewpoint image 310 from the video source 300 and applies known distortion coefficients 305 to generate an undistorted image 155 corresponding to platform viewpoint image 310.

In embodiments, the registering/tracking module 120 aligns the 2D projected image 115 with the undistorted image 155 corresponding to the platform viewpoint image 310 to determine an aimpoint pixel location 125. In other embodiments, the registering/tracking module 120 aligns the 2D projected image 115 with the platform viewpoint image 310 to determine the aimpoint pixel location 125. The determination of the aimpoint pixel location 125 may be achieved using known registration methods, such as taught in, for example, U.S. Pat. No. 10,445,616B2, which is incorporated herein by reference in its entirety. When under conditions wherein platform position information 415 from the GPS unit 400 is lost, the registering/tracking module 120 performs interframe registration to compute a translation vector 135 that indicates that movement of the aimpoint in the platform viewpoint image 310 or the undistorted image 155 from one frame thereof to the next.

In embodiments, the LOS estimator 140 uses the aimpoint pixel location 125 and/or the translation vector 135 in calculating an estimated LOS vector 145 from the platform viewpoint to the aimpoint (azimuth and elevation pointing angles). In embodiments the LOS estimator 140 uses a previously computed actual LOS vector 117, calculated by the mission computer 200 when the platform position information 415 is available, and the translation vector 135 to calculate the estimated LOS vector 145. In embodiments the LOS estimator 140 uses a previously estimated LOS vector 145, previously calculated by the LOS estimator 140, and the translation vector 135 to calculate a subsequent estimated LOS vector 145. In embodiments the estimated LOS vector 145 is outputted to the mission computer 200 to facilitate accurate navigation towards the aimpoint.

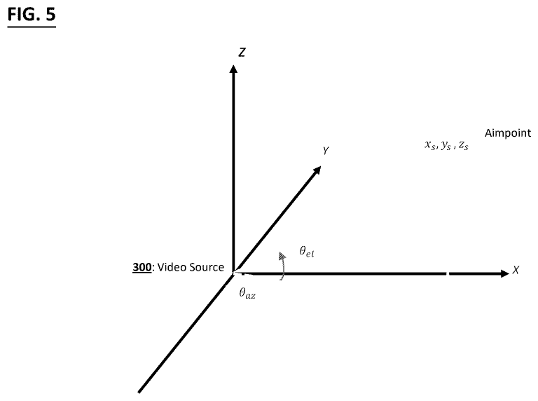

When, in embodiments, the platform position information 415 is received from the GPS unit 400, the actual LOS vector 117 (LOS azimuth and elevation pointing angles) is computed as follows. The actual LOS vector 117 is the pointing vector from the video source 300 to the aimpoint (referencing FIG. 5). As the position of the platform (PlatformECEF) and the aimpoint position (AimpointECEF) are both known in ECEF (Earth Center Earth Fixed) coordinates, the actual LOS vector 117 \vec{v} from video source 300 to the aimpoint is computed as below:

$$\vec{v} = {R}_{body 2 sensor} * {R}_{NED 2 body} * {R}_{platformECEF 2 NED} * ( PlatformECEF - AimpointECEF ) ,$$

### Where:

R_{body2sensor} is the direct cosine matrix transform from platform body RFD (Right-Front-Down) coordinates to the video source 300 (sensor) in terms of the sensor yaw, pitch and roll,
R_{NED2body} is the direct cosine matrix transform from NED (North-East-Down) frame to platform body in terms of the platform yaw, pitch, and roll, and
R_{platformECEF2NED} is the coordinate rotation matrix to convert platform ECEF position to NED coordinates.

A unit vector

$$\hat{v} = \frac{\vec{v}}{\vert v \vert} ,$$

expressed as [xₛ, yₛ, zₛ], is a new sensor frame aligned in the pointing direction, and the azimuth and elevation pointing angles of the actual LOS vector 117 to the aimpoint are computed as

$${θ}_{az} = {tan}^{- 1} ( \frac{{y}_{s}}{{x}_{s}} ) and {θ}_{el} = {tan}^{- 1} ( \frac{{z}_{s}}{{{x}_{s}}^{2} + {{y}_{s}}^{2}} ) ,$$

respectively.

Even when platform position information 415 from the GPS unit 400 is unavailable, an estimated LOS vector 145 (azimuth and elevation pointing angles) can still be calculated based on coordinates of a known aimpoint pixel location 125 in a 2D projected image 115 corresponding to the projected aimpoint. Defining xₚ, y_{q} as the pixel coordinates in the 2D projected image 115 corresponding to the aimpoint, with xₚ, y_{q} being away from the center of the image (x₀, y₀) by p rows and q columns respectively, and knowing instantaneous field of view ifov, i.e., the angle subtended by a single pixel in the detector array out into the scene being imaged, the conversion from pixel coordinates to an estimated LOS vector 145 is given by

$$[ \begin{matrix}1 \\ ( ifov ) * ( {x}_{p} - {x}_{0} ) \\ ( ifov ) * ( {y}_{q} - {y}_{0} )\end{matrix} ] .$$

Therefore, the pointing angles of the estimated LOS vector 145 are respectively estimated as

$${θ}_{az}^{est} = {tan}^{- 1} \{ ( {x}_{p} - {x}_{0} ) * ifov \} , {θ}_{el}^{est} = {tan}^{- 1} \{ \frac{( {y}_{0} - {y}_{q} ) * ifov}{{[ ( {x}_{p} - {x}_{0} ) * ifov ]}^{2} + 1} \}$$

The angular field of view is given by

$$afov = 2 * tan - 1 ( \frac{h}{2 f} ) ,$$

where h is the horizontal dimension of the detector array or sensor. By analogous reasoning, the instantaneous field-of-view ifov is determined by the size of the individual detecting element d, giving

$$ifov = 2 * {tan}^{- 1} ( \frac{d}{2 f} ) .$$

In embodiments, the ifov is approximated by the ratio of pixel pitch to focal length d/f if

$$\frac{d}{f} << 1.$$

The detector pitch d and focal length f are usually provided in the camera datasheet provided by its manufacturer.

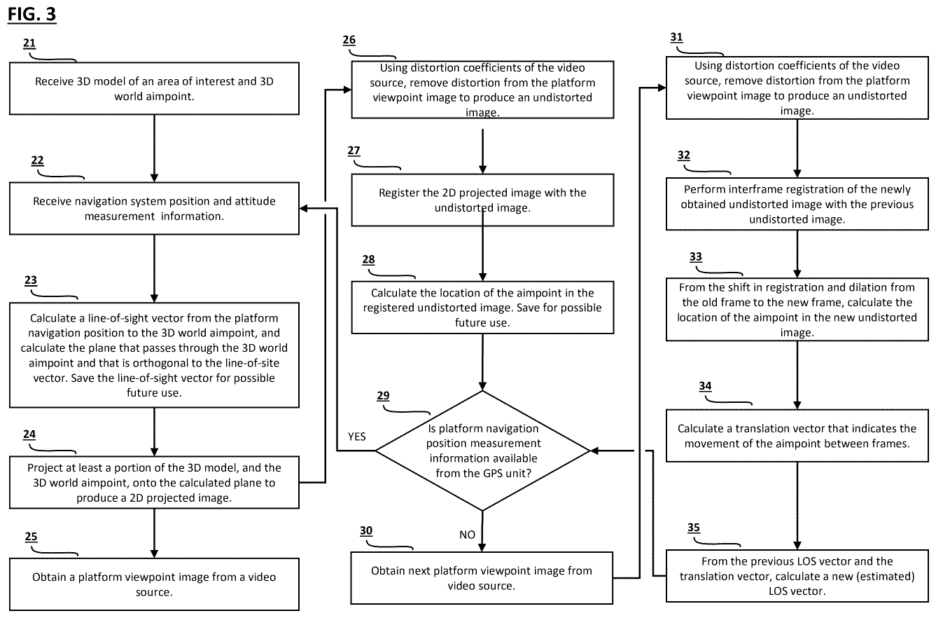

In embodiments, an improvement to existing navigation systems is achieved through provision of a non-transitory computer-readable medium storing a plurality of instructions which, when executed by one or more processors, causes the one or more processors to perform a method for line-of-sight aimpoint tracking. FIG. 3 presents a specific method for aimpoint tracking achieved through provision of a non-transitory computer-readable medium according to an embodiment. The method involves processing data to maintain accurate aimpoint tracking in the absence of GPS data (platform position information 415 from the GPS unit 400).

In embodiments, the method starts by receiving 21 a 3D model 515 of an area of interest and a 3D world aimpoint 505. This information serves as the basis for the subsequent tracking process. This information may be inputted by an operator or remote system prior to launching of the platform, or it may be provided remotely once the platform is underway. In embodiments the area of interest may be determined as an area in the vicinity of the 3D world aimpoint 505. In embodiments this information is received into a computer (not illustrated) that is operating under software control to provide the functions of the line-of-sight aimpoint tracking system 100 described above in reference to FIG. 2.

Platform position measurement information is received 22. This data is for orienting the 3D model 515 relative to the platform's current location and bearing when generating a 2D projected image 115. This position measurement information may be received from, for example, a GPS unit 400.

In embodiments, an actual line-of-sight vector 117 from the platform viewpoint to the 3D world aimpoint 505 is calculated 23 and may be stored for future reference. In embodiments the plane that is orthogonal to this line-of-sight vector 117 and that contains the 3D world aimpoint 505 is calculated using a geometric method.

At least a portion of the 3D model 515 and the 3D world aimpoint 505 are then projected 24 onto the calculated plane to thereby generate a 2D projected image 115 of the 3D model 515, as if it were viewed from the platform viewpoint. In embodiments the 3D model 515 comprises vertices, addressed in a three-dimensional global reference frame, of features that are schematic representations of real-world geography and objects in the environment such as buildings. In embodiments the projected vertices are used to form polygons in the 2D projected plane, and the polygons are in-filled to form a 2D schematic representation of a virtual view of the real world approximately as it is anticipated to appear from the platform viewpoint.

A platform viewpoint image 310 is obtained 25 from a video source, which may be a forward-looking IR camera (FLIR) that points substantially in the direction of travel of the platform, that is, that points in the direction of travel with an allowable angular deviation to account for mounting tolerances, along with operational adjustments to tilt in the downward direction to enhance the capture of ground images. Most importantly the video source is pointed to have the area of interest in the vicinity of the aimpoint in its field of view. This provides a visual reference from the perspective of the platform viewpoint. This platform viewpoint image 310 may be received through the mission computer 200, while in other embodiments this platform viewpoint image 310 may be received directly into the computer or device that is to carry out the distortion removal 26 described below. In yet other embodiments this platform viewpoint image 310 is received directly into the computer or device that is to carry out the registration and tracking 27.

In some embodiments distortion is removed 26 from the platform viewpoint image 310 using the distortion coefficients 305 of the video source 300, yielding an undistorted image 155 to facilitate accurate registration 27, described below. In other embodiments the distortion removal 26 may be omitted, with registration carried out using the platform viewpoint image 310 itself. The distortion removal, i.e. undistortion, may be accomplished using a technique that would be known to one skilled in the art.

In some embodiments the 2D projected image 115 is registered (aligned) 27 with the undistorted image 155, while in other embodiments the 2D projected image 115 is registered 27 with the original platform viewpoint image 310. Given that both the undistorted image 155 and the original platform image 310 correspond to the platform viewpoints, each is considered to be an “image corresponding to the platform viewpoint.” In yet other embodiments the 2D projected image 115 is distorted using the distortion coefficients 305 to thereby match the distortion of the original platform viewpoint image 310, after which the resulting distorted 2D projected image is registered with the platform viewpoint image 310. This registration aligns images from the video source 300 with the results from the 3D model 515, to thereby generate a correspondence between the actual surrounding environment, as viewed from the platform viewpoint, and the 3D model 515.

In embodiments, various image correlation techniques may be used to perform registration of the 2D projected image 115 to the platform viewpoint image 310 or the undistorted image 155. In embodiments, enhanced phase correlation techniques such as taught in, for example, U.S. Pat. No. 10,445,616B2 in particular, which is incorporated by reference in its entirety for all purposes, are used to perform this registration. In embodiments, other methods known in the art may also be used to perform the registration. In embodiments, the correlation may be done in image-space or a transformed space not limited to image gradients, edges and other transformations on the images being correlated. In embodiments, the correlation may be performed on image gradients or variants thereof.

In embodiments, the position and orientation of the camera may be varied numerically to determine the combination which results in a 2D projected image 115 that best registers to the platform viewpoint image 310 or the undistorted image 155. This alignment process may be performed in multiple iterations.

The location of the aimpoint within the registered image is calculated 28 and saved, thereby identifying the aimpoint within the field of view of the platform.

Note that all of the procedures described above are carried out iteratively at short time intervals of, for example, one second or less, as long as the platform position, velocity and attitude measurement information 405 with the position information 415 supplied from the GPS unit 400 are available and require minimal validation. This provides the information for vision-based aimpoint tracking when required due to entering into A2AD conditions or otherwise losing access to precise platform position measurement information 415.

The availability of platform position information 415 from the GPS unit 400 is assessed 29. If available, the process repeats from above, including receiving 22 the platform position and attitude measurement information 405, calculating 23 the LOS vector 117 and the orthogonal plane, projecting 24 at least a portion of the 3D model 505, obtaining 25 a platform viewpoint image 310, removing distortion 26 (if desired), registering 27 the 2D projected image 115, and locating 28 the aimpoint in the undistorted image 155. These procedures all take place in the background concurrently and in parallel with conventional Guidance, Navigation, and Control (GNC) operations. On the other hand, if the platform position information 415 from the GPS unit 400 becomes unavailable, the information generated above serves as the foundation for visual aimpoint tracking to provide a basis for continued high-accuracy navigation in the absence of this information, with the aimpoint tracking achieved as described below.

The next platform viewpoint image 310 is obtained 30 from the video source, 300 enabling a tracking process based on updated visual data. In the same manner as described above, the platform viewpoint image 310 may be subjected to a distortion removal process 31, to produce an undistorted image 155.

Interframe registration 32 is performed between the new undistorted image 155 and the previously stored undistorted image 155, enabling the aimpoint to be tracked across multiple frames. In other embodiments, the undistortion 26 is omitted, and registration is performed using the platform viewpoint image 310 rather than the undistorted image 155. In embodiments images may undergo enhancement prior to registration. In embodiments, this interframe registration 32 is performed via feature-based interframe registration.

Even more specifically, some embodiments use Speeded Up Robust Features (SURF) for the interframe registration 32, while other feature descriptors such as for example, Scale-Invariant Feature Transform (SIFT) or FAST (Features-from-Accelerated-Segment Test) may also work well. An image correlation step may be included to refine image-to-image registration. The image correlation may use the EPC (Enhanced Phase Correlation) technique described in the previously cited U.S. Pat. No. 10,445,616B2.

In embodiments, feature matches between the images (which, in embodiments, may be platform viewpoint images 310, and in other embodiments may be undistorted images 155) undergoing interframe registration may be confined to a local window around or below (i.e., downward in the y direction of the image) the aimpoint, thereby avoiding confusion from adjacent structures coming into view close to or behind a target building as range-to-target decreases.

The aimpoint location is recalculated 33 in the new image (the most recent platform viewpoint image 310 or undistorted image 155) based on a computed image-to-image transformation.

In some embodiments, the interframe registration 32 is the alignment of subsequent video source images that is performed using multiple feature points computed from each image. The transformation from the set of feature points from the previous image to the feature points in the current image is computed. The aimpoint pixel position from the previous image is projected forward to the current image to get the aimpoint pixel position in the current image. Thus, the aimpoint is tracked in subsequent image frames of the video using feature-based interframe registration.

In still further embodiments a predicted platform position may be calculated using a Kalman filter by taking the prior known platform position and current platform velocity into account. When the aimpoint is projected onto the image using this predicted platform position, the projected pixel position is often incorrect. The transformation from this projected pixel to the actual aimpoint pixel position computed from interframe registration is a translation in x,y pixel coordinates tₓ, t_{y}. This translation vector 135 may be used in calculating 35 an estimated line-of-sight vector 145. In other embodiments, wherein the estimated line-of-sight vector 145 is calculated using another technique as described earlier in [0048], this translation vector 135 need not be calculated.

In embodiments, the raw estimated LOS vector 145 may be further refined by the LOS estimator 140 through the use of, for example, a Kalman filter, to provide a smoothed estimated LOS vector 145, which may then be provided to the mission computer 200 for use in platform guidance.

Thereafter, until the platform reaches the aimpoint (or otherwise terminates its flight) the process is repeated from evaluating 29 whether or not the platform position information 415 is available from the GPS unit 400, and then either returning to receiving 22 the platform position, velocity and attitude measurement information 405 or continuing with the aimpoint tracking through interframe registration 30-35.

Note that the reference numerals indicating the process elements above (21 through 35) must not be construed as strictly controlling the sequence in which these process elements are executed; they are provided for case in description rather than to define sequence order, and may be sequenced arbitrarily insofar as obvious data dependencies are satisfied. For example, while obviously removing distortion 26 from the platform viewpoint image must be executed after first obtaining 25 said image, obtaining 25 the platform viewpoint image and removing distortion 26 therefrom could be executed prior to, or in parallel with, the receiving 22 platform position information, calculating 23 the line-of-sight vector, and projecting 24 the 3D model to produce a 2D image.

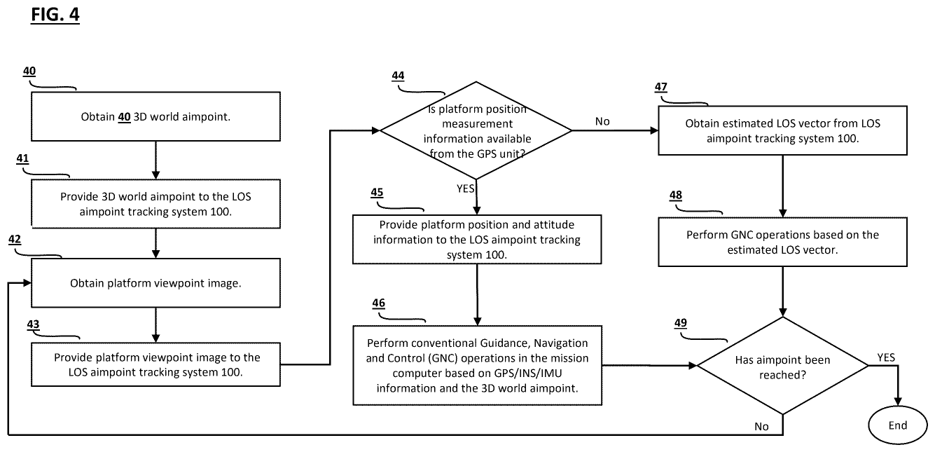

In embodiments, an improvement to existing navigation systems is achieved through provision of a non-transitory computer-readable medium storing a plurality of instructions which, when executed by one or more processors causes the one or more processors to perform a method for line-of-sight aimpoint tracking. FIG. 4 presents a specific method for aimpoint tracking achieved through provision of a non-transitory computer-readable medium according to an embodiment, used in vision-based aimpoint navigation. The method explains guidance of a platform to a designated aimpoint using first direct platform position, velocity and attitude measurement information 405 while it is available, followed by using estimated line-of-sight vectors 145 once GPS-based data, for example, become unavailable, in an expanded explanation of that which was described previously in reference to FIG. 1.

The method starts with obtaining 40 a 3D world aimpoint 505. As with the method described using FIG. 3, this information may be inputted by an operator or a by remote system prior to launching of the platform, or it may be provided remotely once the platform is underway. This aimpoint serves as the target for both the conventional navigation process and for the process that is unique to this disclosure. Note that although no reference is made to obtaining a 3D model 515, for example, at this point, it is assumed here that the line-of-sight aimpoint tracking system 100 (referencing FIG. 2) is provided with all initial data that is required to achieve the functions thereof.

In embodiments, the 3D world aimpoint 505 is provided to the LOS aimpoint tracking system 100. As explained above in reference to FIG. 3, the LOS aimpoint tracking system 100 uses the 3D world aimpoint 505 as a reference for tracking the platform's movement towards the target, in establishing the registration between the data from the 3D model 515 and the images captured by the video source 300.

A platform viewpoint image 310 is obtained 42 from the video source 300, in the same manner as was described above, and is provided 43 to the LOS aimpoint tracking system 100.

Whether platform position information 415 is available from the GPS unit 400 is evaluated 44. If the information is available, the platform position and attitude measurement information 405 is provided 45 to the LOS aimpoint tracking system 100 to be used as explained in reference to FIG. 3, and conventional GNC operations are performed 46 using the mission computer 200 based on the platform position information 415 from the GPS unit 400 and the 3D world aimpoint 505 to navigate the platform towards the aimpoint as long as the platform position information 415 are available.

On the other hand, when platform position information 415 is not available, an estimated LOS vector 145 is obtained 47 from the LOS aimpoint tracking system 100. This vector provides an alternative means for guiding the platform accurately when platform position information 415 is not available or degraded from the GPS unit 400.

GNC operations 48 are then performed based on the estimated LOS vector 145 to guide the platform accurately towards the aimpoint using the aimpoint tracking information, ensuring success for the mission despite the lack of accurate measurement navigation information from the GPS unit 400.

Whether or not the aimpoint has been reached is evaluated 49. Processing is terminated if the aimpoint has been reached; if not, processing loops back to continue GNC operations based on current data, either the platform position information 415 from the GPS unit 400 (if available), or the estimated LOS vector 145 (if not).

As set forth above, the teachings of the present disclosure enable a fast-moving platform, such as a missile or unmanned aerial vehicle, to utilize a video source, such as a Forward-Looking Infra-Red (FLIR) camera, to locate and maintain an aimpoint on a target as the platform approaches the target under Anti-Access/Area Denial (A2AD) and/or GPS denied conditions. When traditional Guidance, Navigation and Control (GNC) solutions fail under such circumstances, a vision-based solution based on the LOS aimpoint tracking system disclosed above provides alternate means of targeting for precision guided platform guidance to ensure mission success.

The foregoing description of the embodiments of the present disclosure has been presented for the purposes of illustration and description. It is not intended to be exhaustive or to limit the present disclosure to the precise form disclosed. Many modifications and variations are possible in light of this disclosure. It is intended that the scope of the present disclosure be limited not by this detailed description, but rather by the claims appended hereto.

A number of implementations have been described. Nevertheless, it will be understood that various modifications may be made without departing from the scope of the disclosure. For example, while in FIG. 2 the platform position information 415 is sent to the model projecting module 110 via the mission computer 200, there is no limitation thereto, but rather this information may be sent from the GPS unit 400 directly to the model projecting module 110, or the model projecting module 110 may be provided with its own GPS unit, separate from that which provides platform position information 415 to the mission computer 200. Although operations are depicted in the drawings in a particular order, this should not be understood as requiring that such operations be performed in the particular order shown or in sequential order, or that all illustrated operations be performed, to achieve desirable results.

The reference numerals used are as follows:
100: Line-of-Sight Aimpoint Tracking System
110: Model Projecting Module
115: Projected 2D Image
120: Registering/Tracking Module
125: Aimpoint Pixel Location
135: Translation Vector
140: LOS Estimator
145: LOS Vector (Azimuth and Elevation Pointing Angles)
150: Distortion Removing Module
155: Undistorted Image
200: Mission Computer
300 Video Source
305: Distortion Coefficients
310: Platform Viewpoint Image
400: GPS Unit
405: Platform Position and Attitude Measurement Information
415: Platform Position and Attitude Measurement Information
500: Vision-based Aimpoint Navigation System
505: 3D World Aimpoint
515: 3D Model of Area of Interest

What is claimed is:

1. A line-of-sight aimpoint tracking system comprising:
a model projecting module configured to receive a 3D model of an area of interest, to receive an aimpoint in a global reference frame, to receive platform position and attitude measurement information indicating a platform viewpoint, and to convert the 3D model of the area of interest to a 2D projected image, including the aimpoint, as viewed from the platform viewpoint; and
a registering/tracking module configured to receive the 2D projected image from the model projecting module, to receive an image corresponding to the platform viewpoint, to register the 2D projected image with the image corresponding to the platform viewpoint, and to determine, in the image corresponding to the platform viewpoint, an aimpoint pixel location corresponding to the aimpoint.

2. The line-of-sight aimpoint tracking system of claim 1, wherein the image corresponding to the platform viewpoint is obtained by a video source configured to capture image data comprising image frames.

3. The line-of-sight aimpoint tracking system of claim 2, wherein the video source is an infrared camera.

4. The line-of-sight aimpoint tracking system of claim 2, wherein the video source is pointed to have, in its field of view, the area of interest wherein the aimpoint is located.

5. The line-of-sight aimpoint tracking system of claim 1, wherein the model projecting module is configured to receive or calculate a line-of-sight vector from the platform position to the aimpoint, to calculate the plane that includes the aimpoint and is orthogonal to the line-of-sight vector, to project, onto that plane, vertices from the 3D model of the area of interest, and to in-fill spaces between the projected vertices to form a projected 2D image of the model of the area of interest as if viewed from the viewpoint of the platform.

6. The line-of-sight aimpoint tracking system of claim 1, wherein the registering/tracking module is configured to conduct interframe registration after having performed image registration.

7. The line-of-sight aimpoint tracking system of claim 1, wherein the registering/tracking module is configured to perform image registration to align the projected and in-filled 2D image of the model of the area of interest with an image of the area of interest acquired by the video source.

8. The line-of-sight aimpoint tracking system of claim 7, wherein the registering/tracking module is configured to locate a pixel, corresponding to a 3D aimpoint that is within the area of interest, on an image acquired by the video source using such image registration.

9. The line-of-sight aimpoint tracking system of claim 1, wherein the registering/tracking module is configured to perform interframe registration to track the aimpoint in a subsequent image from the video source.

10. The line-of-sight aimpoint tracking system of claim 1, wherein the registering/tracking module is configured to keep track of the aimpoint position in a subsequent image by projecting forward an aimpoint pixel location using a transform computed from interframe image registration.

11. A non-transitory computer-readable medium storing a plurality of instructions which when executed by one or more processors causes the one or more processors to perform a method for line-of-sight aimpoint tracking comprising:
receiving aimpoint position information;
receiving platform position and attitude measurement information corresponding to a current position of a platform;
obtaining a platform viewpoint image from a platform-mounted video source;
generating a 2D projected image by projecting at least a portion of a 3D model of an area of interest containing the aimpoint onto a plane from a platform viewpoint based on the received position and attitude measurement information;
locating the aimpoint within the generated 2D projected image;
using image registration to register the 2D projected image with an image corresponding to the platform viewpoint image;
based on the registration between the image corresponding to the platform viewpoint image and the 2D projected image, locating a pixel position of the aimpoint in the image corresponding to the platform image; and
tracking the pixel position of the aimpoint through interframe registration to predict a location of the aimpoint in an image corresponding to a subsequent platform image.

12. The non-transitory computer-readable medium of claim 11, wherein generation of the 2D projected image, including the aimpoint, as viewed from the platform viewpoint comprises calculating a line-of-sight vector from the platform position to the aimpoint, calculating the plane that includes the aimpoint and that is orthogonal to the line-of-sight vector, projecting, onto that plane, vertices from the 3D model, and in-filling spaces between the projected vertices.

13. The non-transitory computer-readable medium of claim 11, wherein tracking the pixel position of the aimpoint through interframe registration is carried out even when platform position and/or attitude information can no longer be received.

14. The non-transitory computer-readable medium of claim 11, wherein the interframe registration comprises feature-based interframe registration.

15. The non-transitory computer-readable medium of claim 11, wherein Speeded Up Robust Features are used for interframe registration.

16. The non-transitory computer-readable medium of claim 11, wherein the interframe registration comprises matching features that are confined to a local window in the vicinity of the acquired aimpoint.

17. The non-transitory computer-readable medium of claim 11, wherein the 3D model is a wireframe model or a point cloud model.

18. The non-transitory computer-readable medium of claim 11, wherein the method for line-of-sight aimpoint tracking further comprises removing of distortion from the platform viewpoint image based on data regarding distortion in the video source.

19. The non-transitory computer-readable medium of claim 11, wherein the method for line-of-sight aimpoint tracking further comprises distorting the 2D projected image based on data regarding distortion in the video source.

20. The non-transitory computer-readable medium of claim 11, wherein the method for line-of-sight aimpoint tracking further comprises enhancing higher-frequency spatial features of the 3D model and the 2D projected image.
